(19) United States
(12) Patent Application Publication
(10) Pub. No.: US 2023/0296927 A1
(43) Pub. Date: Sep. 21, 2023

(54) OPTICAL DEVICE, PHASE SHIFTER, AND OPTICAL COMMUNICATION APPARATUS

(71) Applicant: Fujitsu Optical Components Limited, Kawasaki-shi (JP)

(72) Inventor: Masaki Sugiyama, Kawasaki (JP)

(73) Assignee: Fujitsu Optical Components Limited, Kawasaki-shi (JP)

(21) Appl. No.: 18/062,748

(22) Filed: Dec. 7, 2022

(30) Foreign Application Priority Data
Feb. 3, 2022 (JP) 2022-015669

(51) Int. Cl. G02F 1/01

(52) U.S. Cl. CPC G02F 1/0147; G02F 1/011; G02F 1/0121; G02F 2201/063; G02F 2201/066; G02F 2201/12; G02F 2201/42

(57) ABSTRACT

1An optical device includes a substrate, a dielectric substance that is laminated on the substrate, an optical waveguide that is surrounded by the dielectric substance, and a heater electrode that is disposed on the optical waveguide and that is surrounded by the dielectric substance. The optical waveguide is a rib type optical waveguide that includes a slab and a rib on the slab, that is located below the heater electrode, and that has a structure in which a width of the slab is less than or equal to 11 times a width of the rib.

### CROSS-REFERENCE TO RELATED APPLICATION

This application is based upon and claims the benefit of priority of the prior Japanese Patent Application No. 2022-015669, filed on Feb. 3, 2022, the entire contents of which are incorporated herein by reference.

### FIELD

The embodiments discussed herein are related to an optical device, a phase shifter, and an optical communication apparatus.

### BACKGROUND

Phase shifters are built into an optical modulator and an optical receiver that are included in an optical communication apparatus used for high-speed optical communication. Each of the phase shifters raises the temperature inside an optical waveguide using heater heat and the refractive index in the interior of the optical waveguide caused by the temperature rise is changed accordingly, so that each of the phase shifters shifts, in accordance with a change in the refractive index, the phase of signal light passing through the optical waveguide.

FIG. 15 is a schematic plan view illustrating an example of a phase shifter 200 that is conventionally used, and FIG. 16 is a schematic cross-sectional diagram of the phase shifter 200 taken along line H-H illustrated in FIG. 15. The phase shifter 200 illustrated in FIG. 15 includes a Si substrate 201, a dielectric substance 202, an optical waveguide 203, a heater electrode 204, and an electrode pad 205. The dielectric substance 202 is laminated on the Si substrate 201 and surrounds the circumference of the optical waveguide 203 that is disposed above the Si substrate 201 and the circumference of the heater electrode 204 that is disposed above the optical waveguide 203.

The dielectric substance 202 is a clad layer that is made of, for example, SiO₂ or the like. The optical waveguide 203 is a channel type waveguide that is made of, for example, Si and through which signal light passes. The heater electrode 204 is made of, for example, metal, such as Ti, having a resistance property, generates heater heat in accordance with a drive current, and raises temperature in the interior of the optical waveguide 203. The electrode pad 205 is connected to the heater electrode 204, and includes an input side electrode pad 205A that inputs an electric current to the heater electrode 204, and an output side electrode pad 205B that outputs the electric current from the heater electrode 204.

The phase shifter 200 raises the temperature in the interior of the optical waveguide 203 by the heater heat that is generated in accordance with the drive current flowing to the heater electrode 204. Furthermore, in the optical waveguide 203, the refractive index inside the optical waveguide 203 is changed in accordance with the thermo-optical effect of Si caused by the temperature rise. In addition, the phase shifter 200 shifts the phase of the signal light passing through the interior of the optical waveguide 203 in accordance with a change in the refractive index.
Patent Document 1: U.S. Pat. Application Publication No. 2019/258094
Patent Document 2: International Publication Pamphlet No. WO 2016/92829
Patent Document 3: U.S. Pat. No. 9477039
Patent Document 4: Japanese Laid-open Patent Publication No. 2003-228031

However, an optical propagation loss is increased as a result of a channel type optical waveguide being used in the phase shifter 200 that is conventionally used, so that an amount of drive current flowing to the heater electrode 204 is allowed to increase. Accordingly, it is conceivable to increase the electrode length of the heater electrode 204 in order to reduce the amount of drive current flowing to the heater electrode 204; however, if the electrode length of the heater electrode 204 is increased, an optical insertion loss is increased.

### SUMMARY

According to an aspect of an embodiment, an optical device includes a substrate, a dielectric substance that is laminated on the substrate, an optical waveguide that is surrounded by the dielectric substance, and a heater electrode that is disposed on the optical waveguide and that is surrounded by the dielectric substance. The optical waveguide is a rib type optical waveguide that includes a slab and a rib on the slab, that is located below the heater electrode, and that has a structure in which a width of the slab is less than or equal to 11 times a width of the rib.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an optical communication apparatus according to a present embodiment;

FIG. 2 is a schematic plan view illustrating an example of a phase shifter according to a first embodiment;

FIG. 3 is a schematic cross-sectional diagram of the phase shifter taken along line A-A illustrated in FIG. 2;

FIG. 4 is a schematic cross-sectional diagram of a phase shifter according to a comparative example;

FIG. 5 is a diagram illustrating an example of a relationship between an amount of drive current of the phase shifter and a slab width/rib width;

FIG. 6 is a schematic plan view illustrating an example of a phase shifter according to a second embodiment;

FIG. 7 is a schematic cross-sectional diagram of the phase shifter taken along line B-B illustrated in FIG. 6;

FIG. 8 is a schematic plan view illustrating an example of a phase shifter according to a third embodiment;

FIG. 9 is a schematic cross-sectional diagram of the phase shifter taken along line C-C illustrated in FIG. 8;

FIG. 10 is a schematic cross-sectional diagram of the phase shifter taken along line D-D illustrated in FIG. 8;

FIG. 11 is a schematic plan view illustrating an example of a phase shifter according to a fourth embodiment;

FIG. 12 is a schematic cross-sectional diagram of the phase shifter taken along line E-E illustrated in FIG. 11;

FIG. 13 is a schematic cross-sectional diagram of the phase shifter taken along line F-F illustrated in FIG. 11;

FIG. 14 is a schematic cross-sectional diagram of the phase shifter taken along line G-G illustrated in FIG. 11;

FIG. 15 is a schematic plan view illustrating an example of a conventional phase shifter; and

FIG. 16 is a schematic cross-sectional diagram of the conventional phase shifter taken along line H-H illustrated in FIG. 15.

### DESCRIPTION OF EMBODIMENTS

Preferred embodiments of the present invention will be explained with reference to accompanying drawings. Furthermore, the present invention is not limited to the embodiments. In addition, the embodiments described below may also be used in any appropriate combination as long as the embodiments do not conflict with each other.

### [A] First Embodiment

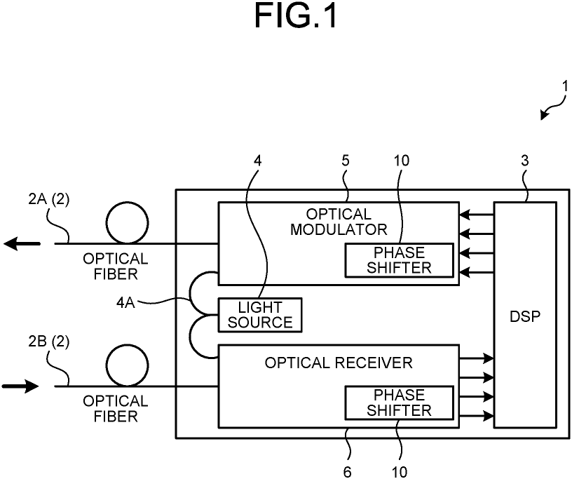

FIG. 1 is a diagram illustrating an example of an optical communication apparatus 1 according to the present embodiment. The optical communication apparatus 1 illustrated in FIG. 1 is connected to an optical fiber 2A (2) that is associated with an output side and an optical fiber 2B (2) that is associated with an input side. The optical communication apparatus 1 includes a digital signal processor (DSP) 3, a light source 4, an optical modulator 5, and an optical receiver 6. The DSP 3 is an electrical component that performs digital signal processing. The DSP 3 performs a process of, for example, encoding transmission data or the like, generates an electrical signal including the transmission data, and outputs the generated electrical signal to the optical modulator 5. Furthermore, the DSP 3 acquires an electrical signal including reception data from the optical receiver 6 and obtains reception data by performing a process of, for example, decoding the acquired electrical signal or the like.

The light source 4 includes, for example, a laser diode or the like, generates light with a predetermined wavelength, and supplies the generated light to the optical modulator 5 and the optical receiver 6. The optical modulator 5 is an optical device that modulates, by using the electrical signal output from the DSP 3, the light supplied from the light source 4 and that outputs the obtained optical transmission signal to the optical fiber 2A. The optical modulator 5 is an optical modulator or the like that includes a phase shifter 10 or the like. The optical modulator 5 generates an optical transmission signal by modulating, at the time when the light supplied from the light source 4 propagates through the waveguide 4A, the light by using the electrical signal that is input to the modulating unit. The phase shifter 10 shifts the phase of the signal light that passes through an optical waveguide 13.

The optical receiver 6 receives the optical signal from the optical fiber 2B and demodulates the received optical signal by using the light that is supplied from the light source 4. Then, the optical receiver 6 converts the demodulated received optical signal to an electrical signal, and then, outputs the converted electrical signal to the DSP 3. Furthermore, the optical receiver 6 also includes the phase shifter 10 or the like.

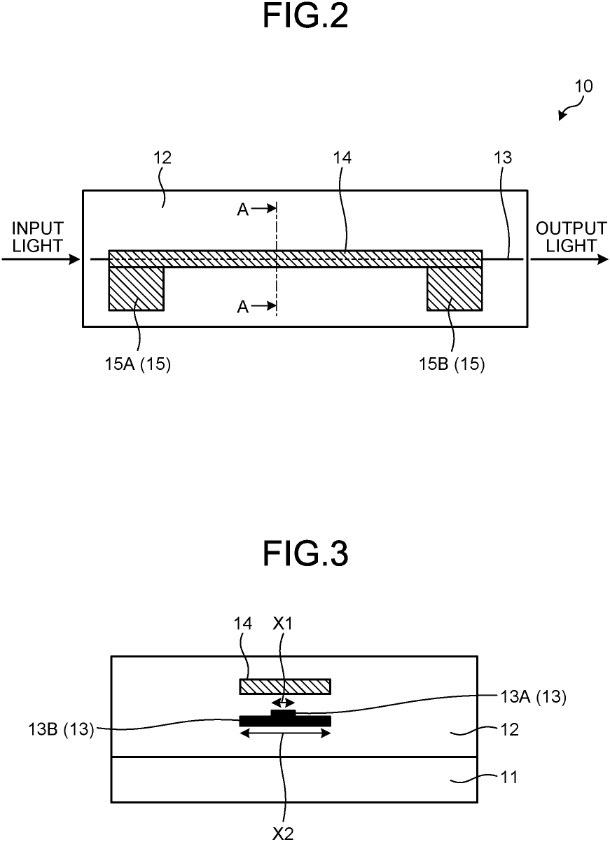

FIG. 2 is a schematic plan view illustrating an example of the phase shifter 10 according to a first embodiment, and FIG. 3 is a schematic cross-sectional diagram of the phase shifter 10 taken along line A-A illustrated in FIG. 2. The phase shifter 10 illustrated in FIG. 2 includes a Si substrate 11, a dielectric substance 12, the optical waveguide 13, a heater electrode 14, and an electrode pad 15.

The dielectric substance 12 is laminated on the Si substrate 11, surrounds the circumference of the optical waveguide 13 that is disposed above the Si substrate 11, and surrounds the circumference of the heater electrode 14 that is disposed above the optical waveguide 13. The dielectric substance 12 is made of, for example, SiO₂ or the like. The optical waveguide 13 inside the dielectric substance 12 is a waveguide that is made of, for example, Si and through which signal light passes. The heater electrode 14 inside the dielectric substance 12 is made of, for example, metal having a resistance property, such as Ti, generates heater heat in accordance with a drive current, and raises the temperature in the interior of the optical waveguide 13 by using the heater heat. The electrode pad 15 includes an input side electrode pad 15A that inputs an electric current to the heater electrode 14 and an output side electrode pad 15B that outputs the electric current from the heater electrode 14.

The optical waveguide 13 is a rib type optical waveguide that includes a rib 13A on a slab 13B. It is assumed that a width dimension X2 of the slab 13B is less than or equal to 11 times a width dimension X1 of the rib 13A. In the phase shifter 10, diffusion of heat is prevented by limiting the width of the slab 13B included in the optical waveguide 13, and thus, a reduction in heating efficiency of the optical waveguide 13 is suppressed. Furthermore, in order to reduce an optical propagation loss, there is a need to increase the width of the slab 13B than the width of the rib 13A, so that an effective way to improve the heating efficiency is to impose a limitation on the width of the slab 13B.

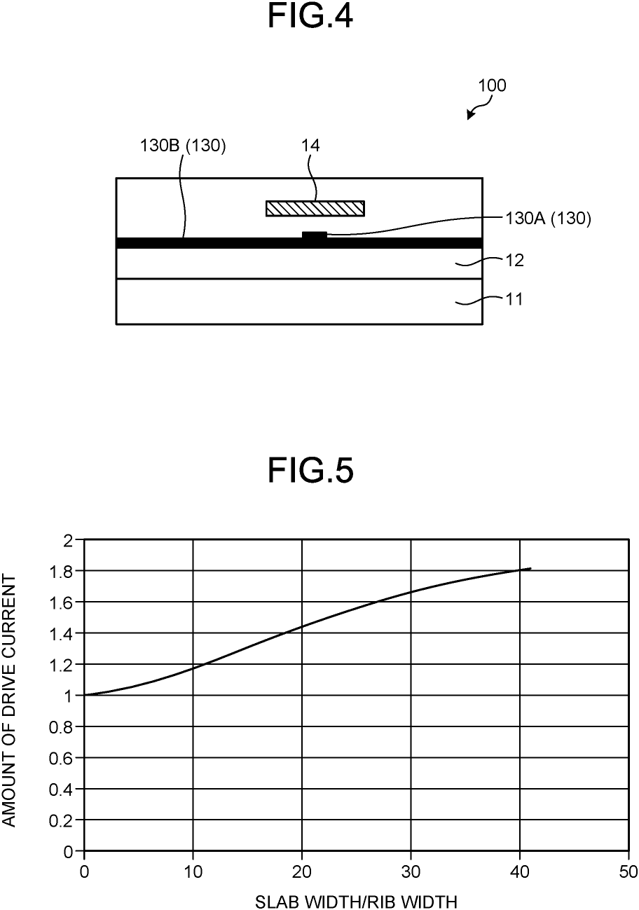

FIG. 4 is a schematic cross-sectional diagram of a phase shifter 100 according to a comparative example. The phase shifter 100 illustrated in FIG. 4 includes the Si substrate 11, the dielectric substance 12, an optical waveguide 130, and the heater electrode 14. In addition, the phase shifter 100 illustrated in FIG. 4 is different from the phase shifter 10 illustrated in FIG. 3 in that the structure of the optical waveguide 130 disposed below the heater electrode 14 is different. The optical waveguide 130 is a rib type optical waveguide that includes a rib 130A on a slab 130B; however, the optical waveguide 130 has a structure in which the width dimension of the slab 130B is larger than 11 times the width dimension of the rib 130A. In the phase shifter 100 according to the comparative example, by using the rib type optical waveguide as the optical waveguide 130 instead of a channel type optical waveguide, it is possible to reduce an optical propagation loss and it is also possible to reduce an optical insertion loss.

It is assumed that the optical loss in the heater electrode 14 is αL, where the length of the optical waveguide 13 is denoted by L and an optical loss per unit length is denoted by α. In the case where the thickness of the rib of the channel type optical waveguide is the same as that of the rib of the rib type optical waveguide, the optical loss per unit length in a case of the channel type optical waveguide is 0.21 dB/mm, whereas the optical loss per unit length in a case of the rib type optical waveguide is 0.14 dB/mm. The length of the optical waveguide 13 in a case of the channel type optical waveguide is 1.2 mm, whereas the length of the optical waveguide 13 in the case of the rib type optical waveguide is 1.44 mm that represents a 20% increase compared to the channel type optical waveguide. Therefore, the optical insertion loss in the case of the channel type optical waveguide is 0.25 dB, whereas the optical insertion loss in the case of the rib type optical waveguide is 0.20 dB. Therefore, the optical insertion loss in the rib type optical waveguide is smaller than the optical insertion loss in the channel type optical waveguide by 0.05 dB.

However, in the phase shifter 100 according to the comparative example, the slab width of Si is large and the thermal conductivity of Si is larger than that of SiO₂, so that the heat generated in the heater electrode 14 is diffused in the slab 130B and the heating efficiency of the optical waveguide 130 is accordingly decreased. As a result, in the phase shifter 100 according to the comparative example, an amount of drive current is allowed to be consequently increased as compared to a case of the phase shifter 10.

FIG. 5 is a diagram illustrating an example of a relationship between an amount of drive current of the phase shifter 10 and the slab width/rib width. For example, the amount of drive current in the heater electrode 204 disposed above the optical waveguide 203 that is a channel type optical waveguide and in which the slab width is one time the rib width is defined as “1”. Then, in the case where the optical waveguide 13 disposed below the heater electrode 14 is changed from the channel type optical waveguide to the rib type optical waveguide, an amount of drive current in the heater electrode 14 needs to be suppressed to an amount less than or equal to 1.2 times the amount of drive current in the channel type optical waveguide from a viewpoint of a reduction in electric power consumption.

Therefore, as in the case of the phase shifter 100 according to the comparative example, the amount of drive current flowing to the heater electrode 14 disposed above the rib type optical waveguide in which the width of the slab 130B is larger than 11 times the width of the rib 130A is larger than 1.2 times the amount of drive current flowing to the heater electrode 204 disposed above the channel type optical waveguide. In contrast, as in the case of the phase shifter 10, it is possible to suppress the amount of drive current flowing to the heater electrode 14 disposed above the rib type optical waveguide in which the width X2 of the slab 13B is less than or equal to 11 times the width X1 of the rib 13A to an amount less than or equal to 1.2 times the amount of drive current flowing to the heater electrode 204 disposed above the channel type optical waveguide.

In the phase shifter 10 according to the first embodiment, the structure has been constituted such that the optical waveguide 13 having the rib type optical waveguide located below the heater electrode 14 is disposed and the width X2 of the slab 13B included in the optical waveguide 13 is less than or equal to 11 times the width X1 of the rib 13A. As a result, the phase shifter 10 is able to reduce the optical insertion loss while reducing the amount of drive current flowing to the heater electrode 14 as compared to a case of the phase shifter 100 according to the comparative example.

In the optical communication apparatus 1, the optical modulator 5 and the optical receiver 6 are integrated on a single chip, so that it is possible to greatly contribute to a reduction in the entire size of the optical communication apparatus 1.

Furthermore, in the phase shifter 10 according to the first embodiment, a case has been described as an example in which the optical waveguide 13 having a single rib type is disposed below the heater electrode 14. However, it may be possible to dispose the optical waveguide 13 having an N rib type below the heater electrode 14, and the embodiment thereof will be described below as a second embodiment.

### [B] Second Embodiment

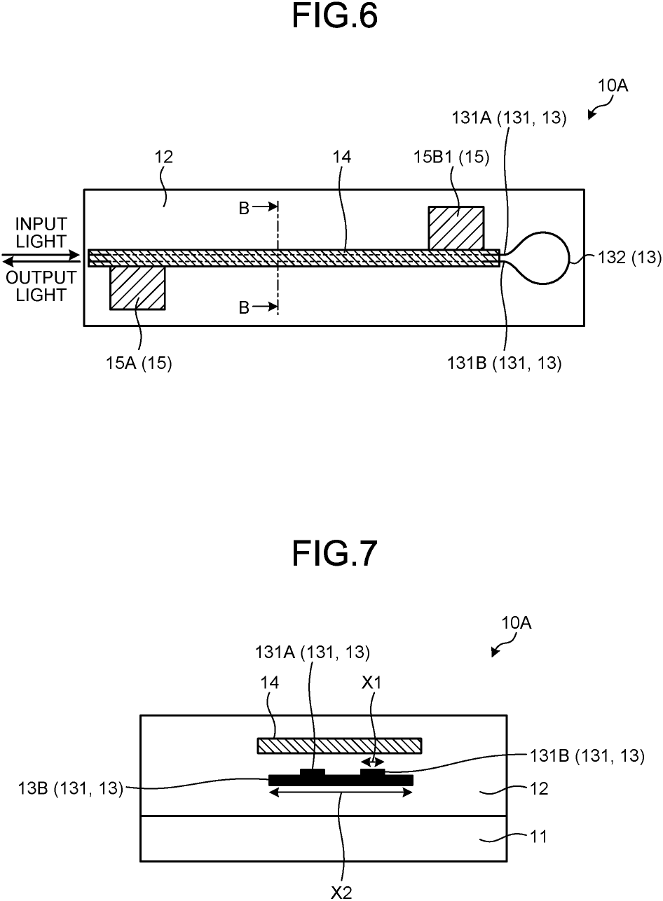

FIG. 6 is a schematic plan view illustrating an example of a phase shifter 10A according to the second embodiment. FIG. 7 is a schematic cross-sectional diagram of the phase shifter 10A taken along line B-B illustrated in FIG. 6. Furthermore, by assigning the same reference numerals to components having the same configuration as those in the phase shifter 10 according to the first embodiment, overlapped descriptions of the configuration and the operation thereof will be omitted. The phase shifter 10A according to the second embodiment is different from the phase shifter 10 according to the first embodiment in that two straight line portions 131 included in the U-shaped optical waveguide 13 having the rib type optical waveguide are disposed in parallel below the heater electrode 14. Furthermore, an output side electrode pad 15B1 is disposed on opposite side of the input side electrode pad 15A connected to the heater electrode 14.

The optical waveguide 13 includes an incoming side straight line portion 131A (131), an outgoing side straight line portion 131B (131), a returning portion 132 that allows the incoming side straight line portion 131A to return the outgoing side straight line portion 131B. Furthermore, in the optical waveguide 13, the incoming side straight line portion 131A and the outgoing side straight line portion 131B are disposed in parallel below the heater electrode 14. The optical waveguide 13 has a structure in which the width dimension X2 of the slab 13B is less than or equal to (11×2) times the width dimension X1 of the rib 13A. In the rib type optical waveguide, confinement of light to the optical waveguide 13 is smaller than that of the channel type optical waveguide, and, if the returning portion 132 is constituted with a small radius of curvature, an optical loss occurs due to an emission of light. However, the optical waveguide 13 has a structure in which the width dimension X2 of the slab 13B is less than or equal to (11×2) times the width dimension X1 of the rib 13A; therefore, even if the returning portion 132 with a small radius of curvature is constituted, it is possible to reduce the optical insertion loss while suppressing the amount of drive current flowing to the heater electrode 14. In addition, it is possible to reduce the size of the phase shifter 10A.

The phase shifter 10A according to the second embodiment has a structure in which the incoming side straight line portion 131A and the outgoing side straight line portion 131B included in the rib type waveguide are disposed below the heater electrode 14, and the width dimension X2 of the slab 13B is less than or equal to (11×2) times the width dimension X1 of the rib 13A. As a result, in the phase shifter 10A, even if the optical waveguide 13 is constituted to have a U-shape structure, it is possible to reduce the optical insertion loss while suppressing the amount of drive current flowing to the heater electrode 14.

In addition, in the phase shifter 10A according to the second embodiment, a case has been described as an example in which the two straight line portions 131 indicated by the incoming side straight line portion 131A and the outgoing side straight line portion 131B are disposed in parallel below the heater electrode 14. However, the number of the straight line portions 131 is not limited two, and the straight line portions 131 that have N straight lines corresponding to two or more straight lines may be used. In this case, any structure may be used for the optical waveguide 13 as long as the width of the slab 13B is less than or equal to (11xN) times the width of the rib 13A, and the number of the straight line portions 131 denoted by N may appropriately be changed.

### [C] Third Embodiment

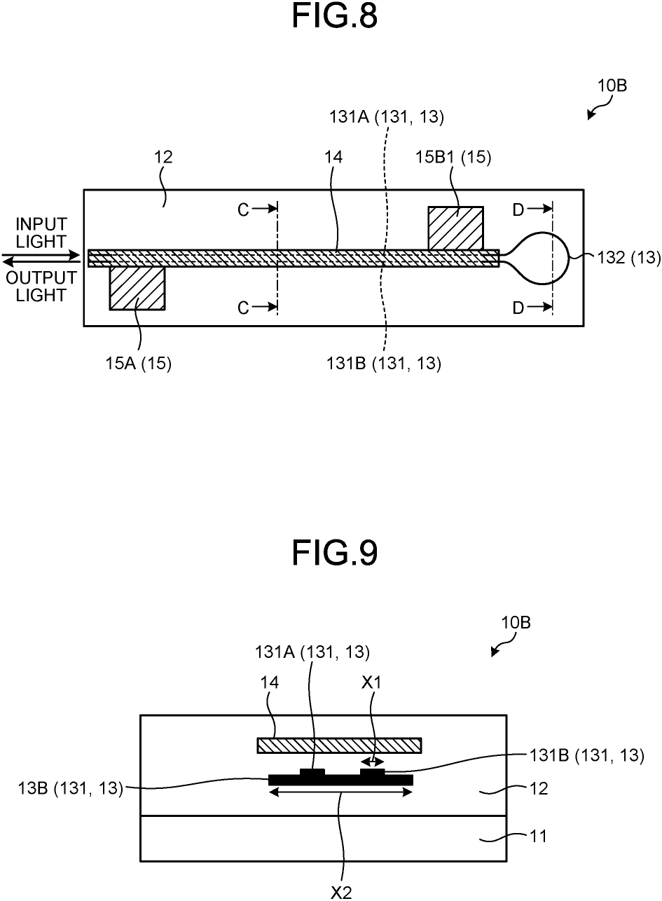

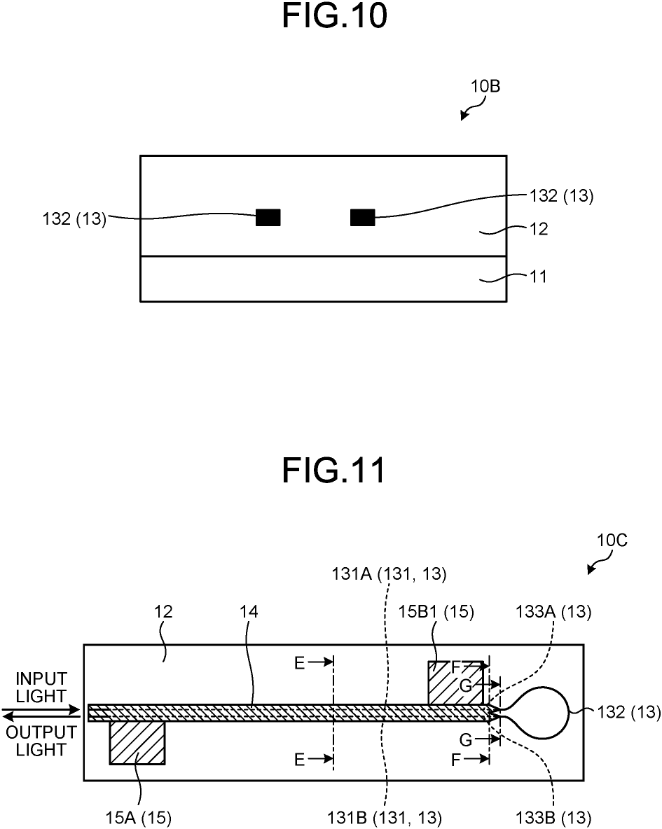

In the following, a phase shifter 10B according to a third embodiment will be described. FIG. 8 is a schematic plan view illustrating an example of the phase shifter 10B according to the third embodiment, FIG. 9 is a schematic cross-sectional diagram of the phase shifter 10B taken along line C-C illustrated in FIG. 8, and FIG. 10 is a schematic cross-sectional diagram of the phase shifter 10B taken along line D-D illustrated in FIG. 8. Furthermore, by assigning the same reference numerals to components having the same configuration as those in the phase shifter 10A according to the second embodiment, overlapped descriptions of the configuration and the operation thereof will be omitted.

The optical waveguide 13 includes the incoming side straight line portion 131A, the outgoing side straight line portion 131B, and the returning portion 132; and the incoming side straight line portion 131A and the outgoing side straight line portion 131B are constituted by a rib type optical waveguide. The returning portion 132 is constituted by a channel type optical waveguide.

The incoming side straight line portion 131A and the outgoing side straight line portion 131B included in the optical waveguide 13 illustrated in FIG. 9 is constituted by the rib type optical waveguide. The returning portion 132 included in the optical waveguide 13 illustrated in FIG. 10 is constituted by the channel type optical waveguide.

The optical waveguide 13 included in the phase shifter 10B according to the third embodiment includes the incoming side straight line portion 131A, the outgoing side straight line portion 131B, and the returning portion 132; the incoming side straight line portion 131A and the outgoing side straight line portion 131B are constituted by the rib type optical waveguide; and the returning portion 132 is constituted by the channel type optical waveguide. As a result, in the phase shifter 10B, the returning portion 132 is constituted by the channel type optical waveguide, so that it is possible to suppress an optical loss in the returning portion 132.

In addition, the phase shifter 10B according to the third embodiment has been structured such that the incoming side straight line portion 131A and the outgoing side straight line portion 131B are constituted by the rib type optical waveguide, and the returning portion 132 is constituted by the channel type optical waveguide. However, a joining portion between the incoming side straight line portion 131A and the returning portion 132, and a joining portion between the outgoing side straight line portion 131B and the returning portion 132 may be constituted to have a tapered shape, and the embodiment thereof will be described below as a fourth embodiment.

### [D] Fourth Embodiment

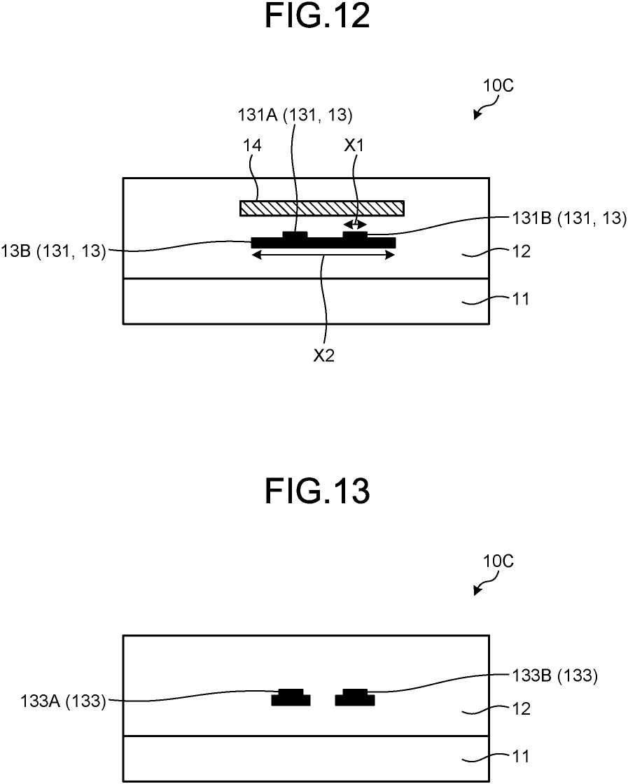

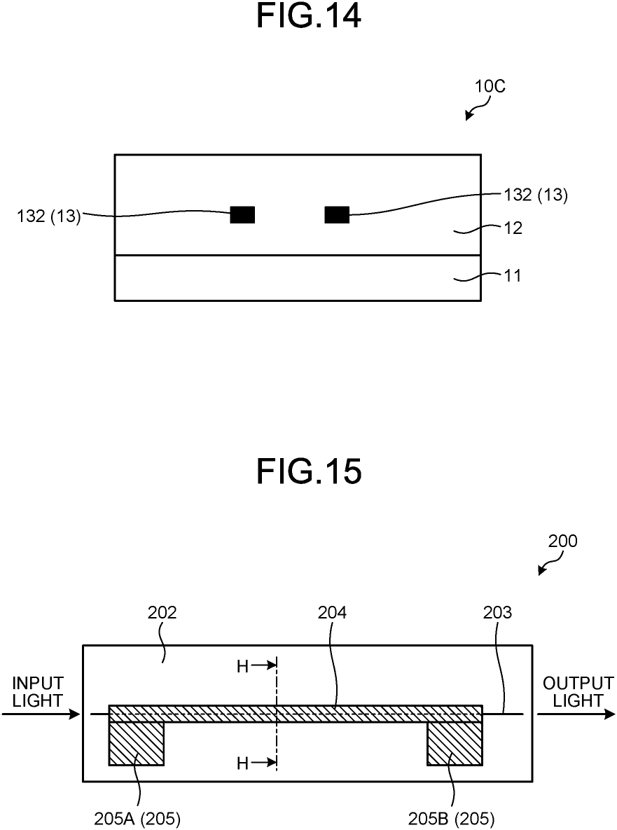

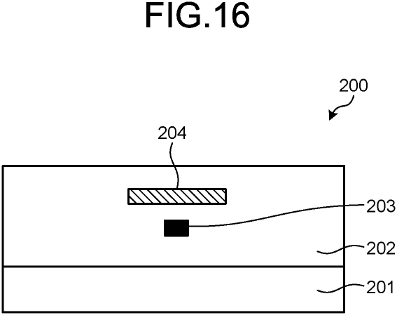

FIG. 11 is a schematic plan view illustrating an example of a phase shifter 10C according to the fourth embodiment, FIG. 12 is a schematic cross-sectional diagram of the phase shifter 10C taken along line E-E illustrated in FIG. 11, FIG. 13 is a schematic cross-sectional diagram of the phase shifter 10C taken along line F-F illustrated in FIG. 11, and FIG. 14 is a schematic cross-sectional diagram of the phase shifter 10C taken along line G-G illustrated in FIG. 11. Furthermore, by assigning the same reference numerals to components having the same configuration as those in the phase shifter 10B according to the third embodiment, overlapped descriptions of the configuration and the operation thereof will be omitted.

The phase shifter 10C according to the fourth embodiment is different from the phase shifter 10B according to the third embodiment in that a joining portion 133 between the straight line portion 131 and the returning portion 132 is constituted to have a tapered shape in which the width of the slab 13B is gradually decreased from the rib type optical waveguide toward the channel type optical waveguide.

The incoming side straight line portion 131A and the outgoing side straight line portion 131B included in the optical waveguide 13 illustrated in FIG. 12 are constituted by a rib type optical waveguide. The returning portion 132 included in the optical waveguide 13 illustrated in FIG. 14 is constituted by a channel type optical waveguide.

The optical waveguide 13 illustrated in FIG. 13 includes an incoming side joining portion 133A located between the incoming side straight line portion 131A and the returning portion 132, and an outgoing side joining portion 133B located between the outgoing side straight line portion 131B and the returning portion 132. The incoming side joining portion 133A has a tapered shape in which the width of the slab 13B is gradually decreased from the incoming side straight line portion 131A corresponding to the rib type optical waveguide toward the returning portion 132 corresponding to the channel side optical waveguide, and the rib 13A located on the incoming side straight line portion 131A is joined to the rib located on the returning portion 132. The outgoing side joining portion 133B has a tapered shape in which the width of the slab 13B is gradually increased from the returning portion 132 corresponding to the channel side optical waveguide toward the outgoing side straight line portion 131B corresponding to the rib type optical waveguide, and the rib 13A located on the outgoing side straight line portion 131B is joined to the rib located on the returning portion 132.

The phase shifter 10C according to the fourth embodiment includes the incoming side joining portion 133A located between the incoming side straight line portion 131A and the returning portion 132, and the outgoing side joining portion 133B located between the outgoing side straight line portion 131B and the returning portion 132. The incoming side joining portion 133A has a tapered shape in which the width of the slab 13B is gradually decreased from the incoming side straight line portion 131A corresponding to the rib type optical waveguide toward the returning portion 132 corresponding to the channel side optical waveguide, and the rib 13A located on the incoming side straight line portion 131A is joined to the rib located on the returning portion 132. The outgoing side joining portion 133B has a tapered shape in which the width of the slab 13B is gradually increased from the returning portion 132 corresponding to the channel side optical waveguide toward the outgoing side straight line portion 131B corresponding to the rib type optical waveguide, and the rib 13A located on the outgoing side straight line portion 131B is joined to the rib located on the returning portion 132. That is, in the phase shifter 10C according to the fourth embodiment, the joining portion 133 between the straight line portion 131 and the returning portion 132 is constituted to have a tapered structure in which the width of the slab 13B is gradually decreased from the rib type optical waveguide toward the channel type optical waveguide. As a result, the phase shifter 10C is able to suppress a sharp change in light by using the tapered structure which gradually changes the width of a portion between the slab 13B of the rib type optical waveguide and the rib disposed on the channel type optical waveguide by.

Furthermore, regarding the phase shifters 10A, 10B, and 10C according to the second to the fourth embodiments, respectively, a case has been described as an example in which the two straight line portions 131 indicated by the incoming side straight line portion 131A and the outgoing side straight line portion 131B are disposed in parallel below the heater electrode 14. However, the number of the straight line portions 131 is not limited to two, but N straight lines corresponding to two or more straight lines may be used for the straight line portions 131, and appropriate modifications are possible.

Regarding the phase shifters 10A, 10B, and 10C according to the second to the fourth embodiments, respectively, a case has been described as an example in which the returning portion 132 included in the optical waveguide 13 is disposed on the downstream side of the output side electrode pad 15B1. However, the returning portion 132 may be disposed inside the output side electrode pad 15B1, and appropriate modifications are possible. As a result, the returning portion 132 is disposed below the output side electrode pad 15B1, it is possible to reduce the entire length of the phase shifters 10A, 10B, and 10C.

A case has been described as an example in which the optical communication apparatus 1 according to the first embodiment has the optical modulator 5 and the optical receiver 6 built in; however, it may be possible to use the optical communication apparatus 1 having only one of the optical modulator 5 and the optical receiver 6 built in, and appropriate modifications are possible.

According to an aspect of an embodiment, it is possible to reduce an optical insertion loss while suppressing an amount of drive current to a heater electrode.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a substrate;
a dielectric substance that is laminated on the substrate;
an optical waveguide that is surrounded by the dielectric substance; and
a heater electrode that is disposed on the optical waveguide and that is surrounded by the dielectric substance, wherein
the optical waveguide is a rib type optical waveguide that includes a slab and a rib on the slab, that is located below the heater electrode, and that has a structure in which a width of the slab is less than or equal to 11 times a width of the rib.

2. The optical device according to claim 1, wherein the optical waveguide has a structure in which the width of the slab is less than or equal to 11 times the width of the rib such that an amount of drive current supplied to the heater electrode is larger than 1 time and less than or equal to 1.2 times as compared to a case where a channel type optical waveguide in which a thickness of a rib is the same as a thickness of the rib included in the rib type optical waveguide is used.

3. The optical device according to claim 1, wherein the optical waveguide located below the heater electrode has a structure in which N straight line portions are returned, the returned N straight line portions are disposed in parallel, and the width of the slab is less than or equal to 11N times the width of the rib.

4. The optical device according to claim 3, wherein the optical waveguide includes
the straight line portions, and
a returning portion that returns the straight line portions,
the straight line portions are constituted by the rib type optical waveguides, and
the returning portion is constituted by the channel type optical waveguide.

5. The optical device according to claim 4, wherein a joining portion between the straight line portions and the returning portion has a structure in which the width of the slab is gradually decreased from the straight line portions to the returning portion.

6. A phase shifter comprising:
a substrate;
a dielectric substance that is laminated on the substrate;
an optical waveguide that is surrounded by the dielectric substance; and
a heater electrode that is disposed on the optical waveguide and that is surrounded by the dielectric substance, wherein
the optical waveguide is a rib type optical waveguide that includes a slab and a rib on the slab, that is located below the heater electrode, and that has a structure in which a width of the slab is less than or equal to 11 times a width of the rib.

7. An optical communication apparatus comprising:
a processor that executes signal processing on an electrical signal;
a light source that emits light; and
an optical modulator that modulates the light emitted from the light source by using an electrical signal that is output from the processor, wherein
a phase shifter included in the optical modulator includes
a substrate,
a dielectric substance that is laminated on the substrate,
an optical waveguide that is surrounded by the dielectric substance, and
a heater electrode that is disposed on the optical waveguide and that is surrounded by the dielectric substance, and
the optical waveguide is a rib type optical waveguide that includes a slab and a rib on the slab, that is located below the heater electrode, and that has a structure in which a width of the slab is less than or equal to 11 times a width of the rib.

8. An optical communication apparatus comprising:
a light source that emits light; and
an optical receiver that demodulates a received optical signal by using the light received from the light source, wherein
a phase shifter included in the optical receiver includes
a substrate,
a dielectric substance that is laminated on the substrate,
an optical waveguide that is surrounded by the dielectric substance, and
a heater electrode that is disposed on the optical waveguide and that is surrounded by the dielectric substance, and
the optical waveguide is a rib type optical waveguide that includes a slab and a rib on the slab, that is located below the heater electrode, and that has a structure in which a width of the slab is less than or equal to 11 times a width of the rib.
